(19) United States
(12) Patent Application Publication
(10) Pub. No.: US 2026/0122483 A1
(43) Pub. Date: Apr. 30, 2026

(54) Method and System for a Communications Network

(71) Applicant: NOKIA SOLUTIONS AND NETWORKS OY, Espoo (FI)

(72) Inventors: Serge Papillon, Paris (FR); Afef FEKI, Sceaux (FR); Siwar KRIAA, Antony (FR)

(21) Appl. No.: 18/683,804

(22) PCT Filed: Aug. 10, 2022
(86) PCT No.: PCT/EP2022/072454

§ 371 Date: Feb. 15, 2024

(30) Foreign Application Priority Data
Aug. 17, 2021 (FI) 20215868

(51) Int. Cl. H04W 12/06; H04W 12/64; H04W 64/00

(52) U.S. Cl. CPC H04W 12/06; H04W 12/64; H04W 64/00

(57) ABSTRACT

A method and apparatus for determining the authenticity of a base station in a communications network are provided. The method includes identifying a plurality of user equipment (UEs) receiving a signal from a base station, receiving data indicative of a distance of each of the UEs of the plurality of UEs to the base station, selecting a subset of UEs from the plurality of UEs, receiving data indicative of a position of each of the of UEs in the subset, determining an estimate of a location of the base station based on the distance and positions of each UE in the subset of UEs and determining whether the base station is an authentic base station based on the estimate.

### TECHNICAL FIELD

The present disclosure relates to a system and method for a communications network. In particular, the method described herein relates to a method of determining whether a base station in a communications network is a real or fake base station.

### BACKGROUND

Communications networks are ubiquitous in society. Radio Access Network communications have been subject to attacks in different mobile networks generations from 2G up to 5G. Even though security between the User Equipment (UE) and the base station have been reinforced in new mobile generations, radio-based attacks are still an issue for all operators and UE manufacturers.

### SUMMARY

It is an object of the invention to provide a method for determining the authenticity of a base station in a communications network.

The foregoing and other objects are achieved by the features of the independent claims. Further implementation forms are apparent from the dependent claims, the description and the figures.

According to a first aspect, a method for determining the authenticity of a base station in a communications network is provided. The method comprises identifying a plurality of user equipment (UEs) receiving a signal from a base station, receiving data indicative of a distance of each of the UEs of the plurality of UEs to the base station, selecting a subset of UEs from the plurality of UEs, receiving data indicative of a position of each of the UEs in the subset, determining an estimate of a location of the base station based on the distance and positions of each UE in the subset of UEs and determining whether the base station is an authentic base station based on the estimate.

In a first implementation form determining whether the base station is authentic comprises accessing location data indicative of locations of a plurality of authentic base stations and comparing the estimated location to the location data.

In a second implementation form the method comprises determining a further estimate for the location of the base station to determine whether the base station has changed position relative to the initial estimate of the location and determining whether the base station is authentic based on the determination.

In a third implementation form determining whether the base station is authentic further comprises accessing mapping data for a geographical region and correlating the estimated location of the base station to the mapping data to determine a likelihood that the base station is authentic.

In a fourth implementation form, data indicative of a distance of each of the UEs of the plurality of UEs is determined based on a received signal strength from the base station.

In a fifth implementation form the method further comprises determining a plurality of groups of UEs based on the received signal strength from the base station and determining respective estimates for the location of the base station for respective groups of UEs.

In a sixth implementation form the method comprises selecting a second subset of UEs from the plurality of UEs on the basis of the estimated location of the base station and positions of the plurality of UEs and determining a second estimated location of the base station based on the estimated distance and position of each UE in the second subset of UEs.

In a seventh implementation form the method comprises selecting one or more further subsets of UEs from the plurality of UEs, estimating, for each of the one or more further subsets, a location of the base station based on the estimated distance and positions of each UE in the respective subset and determining a further estimate of the location of the base station based on the barycentre of the estimated locations of the base station.

In an eighth implementation form the method comprises determining whether an estimated location of the base station is within a pre-determined threshold value.

In a ninth implementation form estimating a location of the base station comprises determining an output of one or more geo-localization algorithms based on the estimated distance and positions of each UE in the subset of UEs.

In a tenth implementation form at least one of the one or more geo-localization algorithms comprises a trilateration algorithm.

According to a second aspect a method for identifying a fake base station is disclosed. The method comprises identifying a plurality of base stations in a geospatial region, identifying UEs that have connected to at least one of the base stations in the plurality of base stations in a pre-determined time period and determining the authenticity of each of the base stations of the plurality of base stations in the geospatial region, according to the method of first aspect.

According to a third aspect an apparatus for a network is provided. The apparatus comprises a processor and a memory storing instructions that, when implemented by the processor cause the processor to identify a plurality of user equipment (UEs) receiving a signal from a base station, receive data indicative of a distance of each of the UEs of the plurality of UEs to the base station,, select a subset of UEs from the plurality of UEs, receive data indicative of a position of each of the UEs in the subset, determine an estimate of a location of the base station based on the distance and positions of each UE in the subset of UEs and determine whether the base station is an authentic base station based on the estimate.

These and other aspects of the invention will be apparent from and the embodiment(s) described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a schematic diagram of an apparatus for a network, according to an example.

FIG. 2 is a flow diagram showing a method for determining the authenticity of a base station, according to an example.

FIG. 3 is a flow diagram showing a method for identifying a fake base station in a region, according to an example.

FIG. 4 shows a flow diagram of a method for determining the authenticity of a base station, according to an example.

FIG. 5 shows a flow diagram of a method for a communications network, according to an example.

FIG. 6 shows a simplified schematic diagram of a computing system, according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Radio Access Network communications have long been subject to different attack methods. In some scenarios attackers use fake or false base stations. According to examples, a fake base station may comprise a deployment of hardware and software to conduct passive and active attacks against mobile subscribers using user tracking, eavesdropping and other techniques. Fake base stations have also been deployed for tracking of criminals and lawful interception. They can also be deployed using open source software and inexpensive equipment such as Universal Software Radio Peripheral hardware.

Fake base stations may also be used as a relay to conduct Man-In-The-Middle (MITM) attacks by impersonating User Equipment (UE) towards the network and, conversely, the network towards the UE. The attacker may be able to intercept and/or modify the communication and eventually redirect the victim towards a malicious server, overcharge the subscriber or deny the service. Detecting fake base stations is an important issue for network operators as attacks can be very damaging. Unfortunately these attacks may be difficult to detect in the case of passive attacks such as IMSI catchers. Active attacks may be detectable more easily as they can be detected by their harmful effects on the network. For example an active attack may lead to Hand Over failures, text message spamming and/or scamming.

The methods and systems described herein may be used to determine the authenticity of a base station. According to examples described herein, a reverse positioning algorithm is used to estimate a location of the base station based on information reported from UEs surrounding the base station. The estimated location may be compared to known locations of base stations or correlated with regional maps to determine a likelihood of whether the base station is a real or fake base station.

In other cases the location of the base station may be tracked in time. In this case, a mobile base station may be a sign that the base station is fake. The location data may be handed to law enforcement agencies to help identify individuals responsible for the attacks.

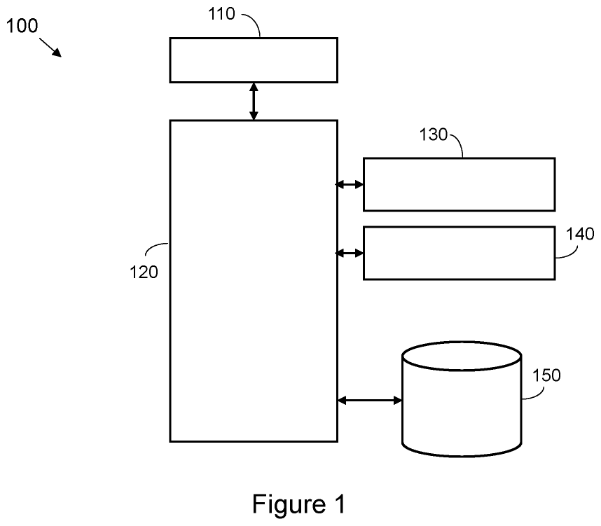

FIG. 1 is a simplified schematic diagram showing an apparatus 100, according to an example. The apparatus 100 may be used in conjunction with other methods and systems described herein.

The apparatus 100 may be implemented in a communications network and may comprise one or more hardware and/or software components. According to examples, the apparatus 100 may be implemented as a standalone device or computing system or may be implemented across multiple networked devices or systems.

The apparatus 100 comprises an interface 110. The interface 110 is a communications interface which connects the apparatus 100 to the core network of a telecommunication infrastructure. According to examples, the interface 110 is communicatively coupled to detection module 120. The detection module 120 executes logic for the main function of the apparatus 100. In particular, the detection module 120 is arranged to identify fake base stations in the communications network. The detection module 120 is arranged to communicate data with the core network via the interface 110. In particular, the detection module 120 may transmit requests for data via the interface 110 and receive data from the core network in response to such requests.

The detection module 120 is communicatively coupled to geolocalization modules 130, 140. The geolocalization modules 130, 140 are arranged to implement different geolocalization algorithms. According to examples, such geolocalization algorithms may include a trilateration algorithm. The detection module 120 is further coupled to a database 150. The database 150 may comprise geolocation data and metadata for a plurality of base stations in the communications network.

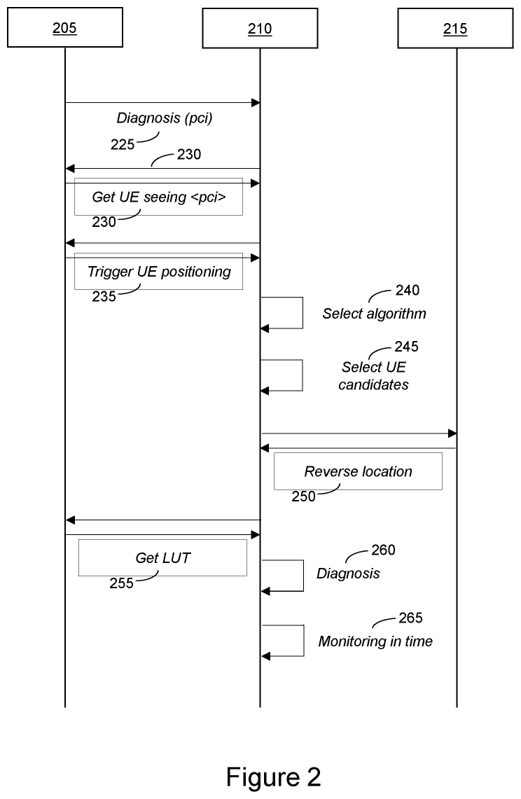

FIG. 2 is a flow diagram of a method 200 for determining the authenticity of a target base station in a communications network, according to an example. The method 200 shown in FIG. 2 may be implemented on the apparatus 100 shown in FIG. 1. The method 200 is implemented between a core network 205 and a detection module 210. In FIG. 2, the detection module 210 is configured to use geolocalization algorithm 215. Alternatively the detection module 210 may use a second geolocalization algorithm. In some cases the detection module 210 may utilise a plurality of geolocalization algorithms and correlate results from the algorithms. The geolocalization algorithms may be implemented on the geolocalization modules 130, 140 shown in FIG. 1.

In FIG. 2, the target base station may be identified by a Physical Cell Identifier (PCI). In other examples, other forms of identifier may be used for the target base station. The process of identifying a base station as authentic begins at 225 with a request to diagnose the base station from the core network 205.

On reception of a request to diagnose the base station, as identified by its PCI, the diagnosis module 210 sends a request to the core network 205, for a list of all the User Equipment (UEs) which have seen the target base station. In other words, the list of UEs which have received some signal broadcast by the target base station.

At stage 235 the diagnosis module 210 communicates a request to the core network 205 for location data and/or additional metadata for a subset of the UEs. At 240 the diagnosis module 210 selects an algorithm which will be used to perform reverse geolocalization for the target base station on the basis of the positions of the UEs. According to examples, the reverse geolocalization algorithm may be a trilateration algorithm. The algorithm may be selected on the basis of the positions of UEs in the subset and additional metadata such as Received Signal Strength (RSS). At 245, a group of candidate UEs are selected from the subset of UEs.

At 250, the diagnosis module 210 triggers the selected geolocalization algorithm to perform the reverse localization of the target base station. The input comprises the location data and additional metadata such as the RSS to estimate a location of the target base station. At 255, the diagnosis module 210 requests locations of legitimate base stations from the core network 205. The core network 205 may use a Look Up Table (LUT) comprising the locations of authentic base stations. At 260, the diagnosis module 210 performs diagnosis based on the estimated location of the target base station and the locations of authentic base stations to determine whether the target base station is authentic.

In some examples, further data may be used to determine if the base station is authentic. For example, regional and/or city maps may be used. The location of the target may be compared to known features in a city such as buildings or roads, to determine a likelihood of whether the base station is authentic.

In some cases, at 265, if the target base station is considered to be a fake base station the diagnosis module 210 may continue to monitor and perform reverse geolocalization of the base station. The location data for the base station may be stored and timestamped in a database such as database 150 shown in FIG. 1. The data may be stored with additional metadata such as the RSS of UEs that connected to the base station. This data may be used at a late point in time for determining whether a further base station is authentic or for law enforcement purposes, for example.

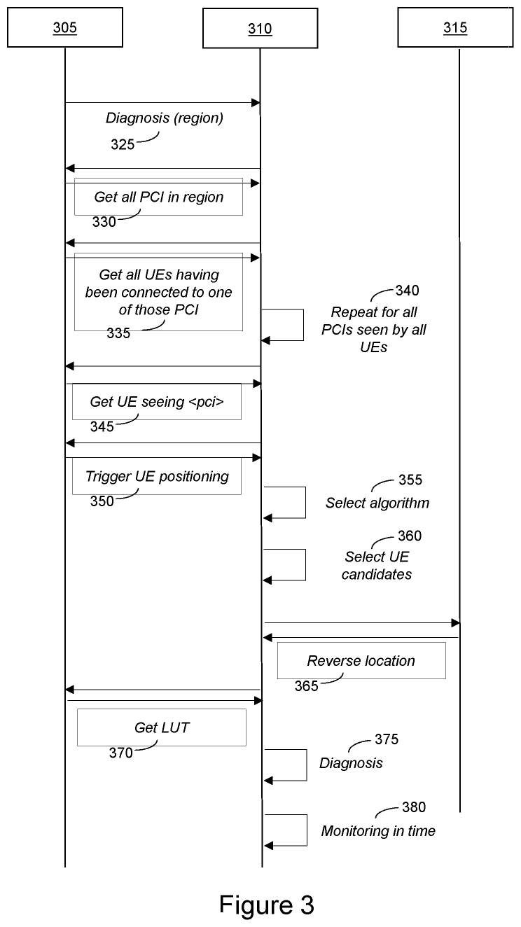

FIG. 3 is a flow diagram showing a method 300, according to an example. The method shown in FIG. 3 permits identification of a fake base station without a PCI or other form of identifier for a target base station. The method 300 may be used in conjunction with other systems and methods described herein including the apparatus shown in FIG. 1. The method 300 is performed between a core network 305 and diagnosis module 310, similar to those previously described. The diagnosis module 310 has access to a geolocalization algorithms 315 which may be used to perform reverse localization. In some cases the diagnosis module 310 may have access to further geolocalization algorithms.

In FIG. 3, at 325 the diagnosis module 310 gets all the PCIs for base stations within a target region. According to examples, this may be achieved directly or by computing a Look Up Table. At 330, the diagnosis module 310 requests all of the UEs that have been connected to at least one of the base stations in the target region, within a time period. In some cases, the diagnosis module 310 may also get the list, for each UE, of all PCIs whose power has been reported by that UE i.e. the RSS.

At 340, for all PCIs that are seen by all the UEs, the steps of the method 200 are performed. That is for each PCI, the diagnosis module 310 obtains, at 345, data from the core network 305 listing all the UEs seeing the PCI. At 350, for each PCI, the diagnosis module 310 triggers positioning to obtain location data for the UEs seeing the PCI. At 355, the diagnosis module 310 selects a geolocalization algorithm to use for reverse positioning of the target PCI. At 360 a group of UEs are selected to use as input to the reverse positioning of the target PCI. At 365 the diagnosis module 310 triggers the geolocalization to perform the reverse positioning. At 370, the diagnosis module obtains the locations of legitimate base stations from the core network 305. At 375 the diagnosis module 310 diagnoses the base station as legitimate or fake on the basis of the reverse lookup. At 380 the diagnosis module 310 may continue to monitor the base station in time to obtain additional location data.

In some cases, diagnosis may be performed for a subset of the PCIs. For example, diagnosis may be performed for a subset of PCIs based on a criteria such as those PCI for which one or more handover failures have been reported.

According to examples, different geolocalization algorithms may be implemented to perform the reverse localization of a base station. In one example, a trilateration algorithm may be used. A trilateration algorithm takes as parameters the locations data for a plurality of UEs as well as the distance of each UE to a target base station. Distances to the base station may be determined using a formula to estimate distance based on the RSS.

In one example, rather than running the trilateration algorithm directly with N different UE locations, the algorithm may be run for each group of M out of the N different UE locations where M is greater than or equal to three, to determine multiple estimates for the position of the base station. The algorithm may then determine the barycentre of the estimated positions. This results in a higher accuracy for the position of the base station.

In some cases, in addition to generating multiple estimates for the location by running the algorithm for each group of three (or more) UEs, the algorithm may further be optimized by removing the outlying estimates for the location of the base station, prior to calculating the barycentre of the estimated positions. This further improves the estimate for the position of the base station.

In some cases, in order to increase the chance a UE connects to it, a fake base station will emit signals with a higher power than advertised. In these cases, evaluating the Received Signal Strength-to-distance formula gives a false distance, putting the fake base station much closer to the UE than it is in reality. In order to mitigate this, rather than estimating a single location, a family of locations for each run of the algorithm may be estimated. Each location in the family corresponds to a different supposed power emission from the fake base station. By correlating the estimates with other data, such as regional map data, an estimate for the location of the target base station may be selected from the family as the most likely location. For example, if the base station is a mobile base station, the most likely position is on a road as opposed to a location which implies the base station is moving through buildings.

The precision of the reverse localization methods described herein are very high when the UEs are surrounding the target base station. Hence, the choice of UEs to input into the geolocalization algorithm from among potential UE candidates near the base station is a significant factor for efficiently locating the base station. After one round of the algorithm, an estimate for the location of the target base station is obtained. UEs may then be selected which surround the estimated location and the algorithm may be re-run using this newly selected group of UEs. This process may be repeated several times in order to narrow down to a very precise location. The best selection of UEs may depend in part on which geolocalization algorithm is used.

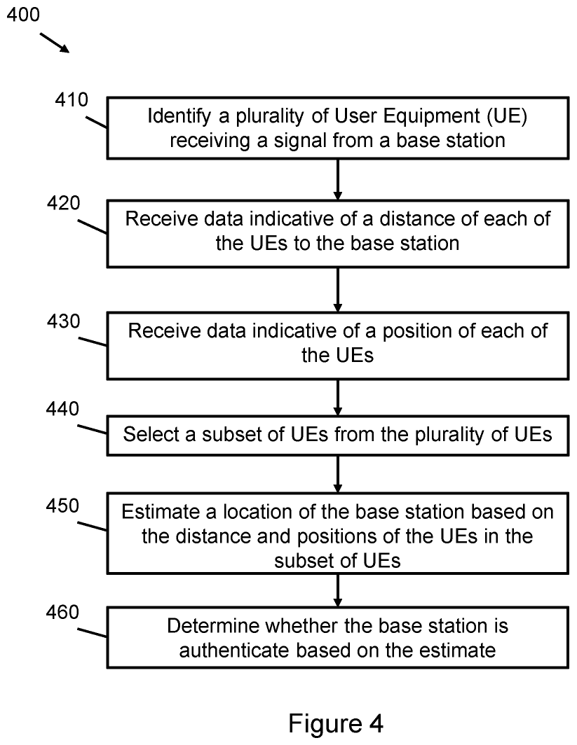

FIG. 4 is a block diagram of a method 400, for determining the authenticity of a base station, according to an example. The method 400 may be implemented in conjunction with the methods and systems described herein.

At block 410 the method 400 comprises identifying a plurality of user equipment (UEs) receiving a signal from a base station. At block 420, the method comprises receiving data indicative of a distance of each of the UEs of the plurality of UEs to the base station. The method 400 comprises receiving data indicative of a position of each of the plurality of UEs at block 430. At block 440, a subset of UEs are selected from the plurality of UEs. At block 450 an estimate of a location of the base station based on the distance and positions of each UE in the subset of UEs is determined. At block 460 it is determined whether the base station is an authentic base station based on the estimate.

The methods and systems described herein may be implemented in any kind of cellular network. In particular, 2G, 3G, 4G and 5G networks. According to examples, the methods may be integrated in 5G networks using the Network Data Analytics Function (NWDAF). This function permits data collection and data analytics in a centralized manner as well as data analysis to improve 5G network management automation.

The NWDAF serves use cases belonging to one or several domains, including Quality of Service, traffic steering, dimensioning and security. The input data of the NWDAF may come from multiple sources, and the resulting actions undertaken by the consuming NF or AF may concern several domains such as Mobility Management, Session Management, QoS management, Application Layer, Security Management, NF Life Cycle Management.

According to examples, NWDAF may be used to support a service for fake base station detection triggered by handover Key Performance Indicators (KPIs).

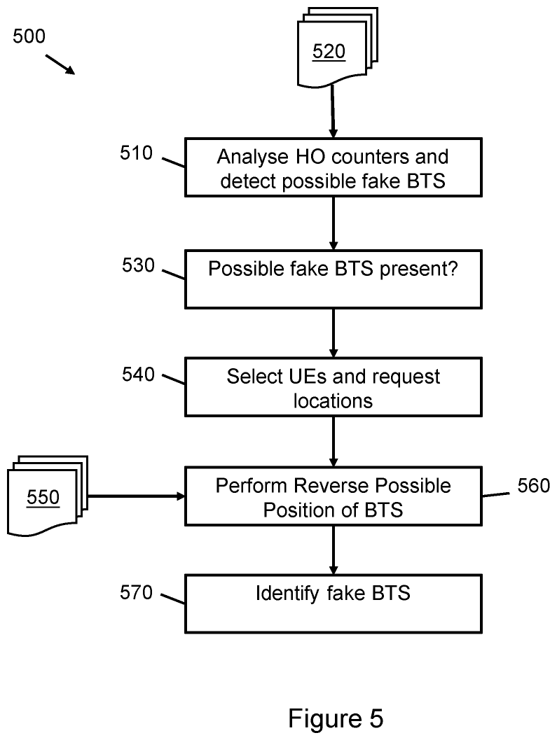

FIG. 5 shows a diagram of a method 500 that may be implemented by the NWDAF of a 5G communications network, according to an example. At block 510 the NWDAF receives and analyses Handover KPI data 520, to detect a possible presence of a fake base station. At block 530 a possible presence of fake base station is diagnosed on the basis of Handover KPI data 520. At block 540, when a possible fake base station is detected the NWDAF requests a set of UEs to report their geographical locations. According to examples, this request is made towards the NF Service Consumer which in turn requests the UE locations to the Location Management Function with a DetermineLocation Request. Once UE positions 550 are received, at block 560 a reverse positioning of the base station localization is performed and, at block 570 a comparison to the database of legitimate base station positions allows the NWDAF to pinpoint a fake base station.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

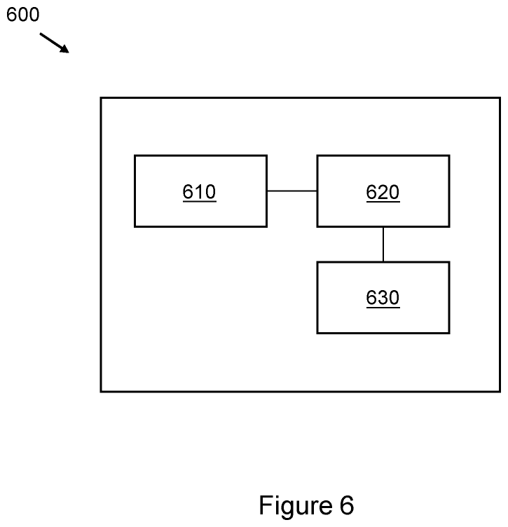

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors. Such machine-readable instructions may also be stored in a computer readable storage that can guide the computer or other programmable data processing devices to operate in a specific mode. FIG. 6 shows an example 600 of a processor 610 associated with a memory 620. The memory 620 comprises computer readable instructions 630 which are executable by the processor 610.

The instructions 630 cause the processor 610 to identify a plurality of user equipment (UEs) receiving a signal from a base station, receive data indicative of a distance of each of the UEs of the plurality of UEs to the base station, receive data indicative of a position of each of the plurality of UEs, select a subset of UEs from the plurality of UEs, determine an estimate of a location of the base station based on the distance and positions of each UE in the subset of UEs and determine whether the base station is an authentic base station based on the estimate.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams. Further, the teachings herein may be implemented in the form of a computer software product, the computer software product being stored in a storage medium and comprising a plurality of instructions for making a computer device implement the methods recited in the examples of the present disclosure.

The present inventions can be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

1. A method for determining the authenticity of a base station in a communications network, the method comprising:
identifying a plurality of user equipment receiving a signal from a base station;
receiving data indicative of a distance of the plurality of user equipment to the base station;
selecting a subset of user equipment from the plurality of user equipment;
receiving data indicative of a position user equipment in the subset;
determining an estimate of a location of the base station based on the distance and positions of the subset of user equipment; and
determining whether the base station is an authentic base station based on the estimate.

2. The method of claim 1, wherein determining whether the base station is authentic comprises:
accessing location data indicative of locations of a plurality of authentic base stations; and
comparing the estimated location to the location data.

3. The method of claim 1, wherein determining whether the base station is authentic, comprises:
determining a further estimate for the location of the base station to determine whether the base station has changed position relative to the initial estimate of the location; and
determining whether the base station is authentic based on the determination.

4. The method of claim 1 wherein determining whether the base station is authentic further comprises:
accessing mapping data for a geographical region and correlating the estimated location of the base station to the mapping data to determine a likelihood that the base station is authentic.

5. The method of claim 1, wherein data indicative of a distance of the plurality of user equipment is determined based on a received signal strength from the base station.

6. The method of claim 1, further comprising determining a plurality of groups of the user equipment based on the received signal strength from the base station and determining respective estimates for the location of the base station for respective groups of user equipment.

7. The method of claim 1, comprising:
selecting a second subset of the plurality of user equipment on the basis of the estimated location of the base station and positions of the plurality of user equipment; and
determining a second estimated location of the base station based on the estimated distance and position of the second subset of user equipment.

8. The method of claim 1 comprising
selecting one or more further subsets of the plurality of user equipment;
estimating, for the one or more further subsets, a location of the base station based on the estimated distance and positions of the respective subset; and
determining a further estimate of the location of the base station based on the barycentre of the estimated locations of the base station.

9. The method of claim 5, further comprising determining whether an estimated location of the base station is within a pre-determined statistical threshold of the other estimated locations, and ignoring the estimation based on the determination.

10. The method of claim 1, wherein estimating a location of the base station comprises determining an output of one or more geo-localization algorithms based on the estimated distance and positions of the subset of user equipment.

11. The method of claim 10, wherein at least one of the one or more geo-localization algorithms comprises a trilateration algorithm.

12. A method comprising:
identifying a plurality of base stations in a geospatial region, identifying user equipment that have connected to at least one of the base stations in the plurality of base stations in a pre-determined time period; and
determining the authenticity of each of the base stations of the plurality of base stations in the geospatial region, according to the method of claim 1.

13. A non-transitory computer readable storage comprising program code that, when executed by a processor, provides instructions to perform the method according to claim 1.

14. An apparatus for a network, the apparatus comprising:
at least one processor; and
at least one non-transitory memory storing instructions that, when implemented by the at least one processor cause the apparatus to:
identify a plurality of user equipment receiving a signal from a base station;
receive data indicative of a distance of the plurality of user equipment to the base station;
select a subset of the plurality of user equipment;
receive data indicative of a position of the user equipment in the subset;
determine an estimate of a location of the base station based on the distance and positions of the user equipment in the subset of user equipment; and
determine whether the base station is an authentic base station based on the estimate.
